(19) United States
(12) Patent Application Publication
(10) Pub. No.: US 2022/0144120 A1
(43) Pub. Date: May 12, 2022

(54) TECHNIQUES FOR CONFIGURING ELECTRIC VEHICLE SUPPLY EQUIPMENT

(71) Applicant: Enel X North America, Inc., Boston, MA (US)

(72) Inventors: Daniel Feldman, San Jose, CA (US); Roman Kleinerman, Austin, TX (US); Michele Guadagno, Salerno (SA) (IT)

(21) Appl. No.: 17/453,807

(22) Filed: Nov. 5, 2021

Related U.S. Application Data
(60) Provisional application No. 63/110,863, filed on Nov. 6, 2020.

(51) Int. Cl. B60L 53/62; B60L 53/66; B60L 53/30; B60L 55/00; H04W 4/80

(52) U.S. Cl. CPC B60L 53/62; B60L 53/66; H04W 4/80; B60L 55/00; B60L 53/305

(57) ABSTRACT

Techniques for configuring electric vehicle supply equipment (EVSE) are disclosed. The disclosed embodiments configure one or more parameters of an EVSE according to a configuration file that corresponds to a location of the EVSE. The EVSE then charges an electric vehicle (EV) according to such configuration. The location can be obtained determined by onboard circuitry for determining a location of the EVSE or by wireless connectivity with a computing device in proximity to the EVSE. Configuration file(s) for the EVSE, along with information regarding locations to which those configuration file(s) correspond, may be located in a memory of the EVSE and/or provided to the EVSE over a network connection. Values for parameters (e.g., as recorded in the configuration files) may be adjusted by a user (e.g., using a user interface of the EVSE or of a user computing device).

### RELATED APPLICATIONS

The present application claims priority to U.S. Provisional Application No. 63/110,863, titled TECHNIQUES FOR CONFIGURING ELECTRIC VEHICLE SUPPLY EQUIPMENT, filed Nov. 6, 2020, the entirety of which is incorporated herein by reference.

### TECHNICAL FIELD

The present disclosure generally relates to the field of configuring an electric vehicle supply equipment (EVSE). More particularly, techniques for configuring an EVSE using location data are disclosed.

### BRIEF DESCRIPTION OF THE DRAWINGS

The present embodiments will become more fully apparent from the following description, taken in conjunction with the accompanying drawings. Understanding that the accompanying drawings depict only typical embodiments, and are, therefore, not to be considered limiting of the scope of the disclosure, the embodiments will be described and explained with specificity and detail in reference to the accompanying drawings.

FIG. 1 shows a diagram of an EVSE in accordance with some embodiments of the present disclosure.

FIG. 2 shows a system according to some embodiments of the present disclosure.

FIG. 3 is a flow diagram of a process for configuring an EVSE according to some embodiments of the present disclosure.

FIG. 4 is a flow diagram of a process for determining a current location of an EVSE according to some embodiments of the present disclosure.

FIG. 5 is a flow diagram of another process for configuring an EVSE according to some embodiments of the present disclosure.

FIG. 6 shows a profile for a user and/or account holder associated with an EVSE according to some embodiments of the present disclosure.

### DETAILED DESCRIPTION

It will be readily understood that the components of the embodiments as generally described and illustrated in the figures herein could be arranged and designed in a wide variety of different configurations. Thus, the following more detailed description of various embodiments, as represented in the figures, is not intended to limit the scope of the disclosure, as claimed, but is merely representative of various embodiments. While the various aspects of the embodiments are presented in drawings, the drawings are not necessarily drawn to scale unless specifically indicated.

Moreover, the phrases “connected to” and “coupled to” are used herein in their ordinary sense, and are broad enough to refer to any suitable coupling or other form of interaction between two or more entities, including mechanical, fluid, and thermal interaction. Two components may be coupled to each other even though they are not in direct contact with each other. The phrase “attached to” refers to interaction between two or more entities which are in direct contact with each other and/or are separated from each other only by a fastener of any suitable variety (e.g., an adhesive, etc.).

The terms “a” and “an” can be described as one, but not limited to one. For example, although the disclosure may recite an element having, e.g., “a line of stitches,” the disclosure also contemplates that the element can have two or more lines of stitches.

Unless otherwise stated, all ranges include both endpoints and all numbers between the endpoints.

Reference throughout this specification to “an embodiment” or “the embodiment” means that a particular feature, structure, or characteristic described in connection with that embodiment is included in at least one embodiment. Thus, the quoted phrases, or variations thereof, as recited throughout this specification are not necessarily all referring to the same embodiment. Not every embodiment is shown in the accompanying illustrations; however, at least a preferred embodiment is shown. At least some of the features described for a shown preferred embodiment are present in other embodiments.

The term electric vehicle (EV), as used herein, refers to a motorized vehicle deriving locomotive power, either full-time or part-time, from an electric system on board the motorized vehicle. By way of non-limiting examples, an EV may be an electrically powered passenger vehicle for road use; an electric scooter; an electric fork lift; a cargo-carrying vehicle powered, full-time or part-time, by electricity; an off-road electrically powered vehicle; an electrically powered watercraft; etc.

The term electric vehicle supply equipment (EVSE), as used herein, refers to equipment by which an EV may be charged or recharged. An EVSE may comprise or be coupled to a computing system whereby service to the EV is provisioned, optionally, according to parameters. In some embodiments, values for the parameters are operator-selectable. Alternatively, or in addition, the values for the parameters may be automatically selected. An EVSE may comprise a means of providing cost accounting, and may further comprise a payment acceptance component. An EVSE may be installed at a home or residence of an owner/operator of an EV, at a place of business for an owner/operator of an EV, at a fleet facility for a fleet comprising one or more EVs, at a public charging station, etc. The present disclosure uses the terms EVSE and “charging station,” where for purposes of this disclosure, an EVSE is an example of a charging station.

An EVSE may be portable such that it can be brought by a user to various locations and used to charge an EV. For example, a user may install and use an EVSE at home to charge an EV. The user may then travel to a friend or family member's home, bringing the EVSE, and install and use the EVSE to charge the EV at the friend or family member's home.

The EVSE can be installed by connecting a plug of the EVSE to an electrical outlet at the installation location. The EVSE may then be used to deliver electricity to an EV for charging. However, electrical conditions may vary based on the installation location, which may impact EVSE performance, and the EVSE may need to be configured at different installation locations. Configuring the EVSE may be time and/or labor intensive, but improper configuring can be detrimental. For example, a maximum current delivered by the EVSE may vary based on the electrical conditions where the EVSE is installed, so the EVSE may need to be configured to determine a correct maximum current. Otherwise, use of the EVSE having an improper configuration may cause an electrical fault, tripping a circuit breaker of the installation location and disrupting charging. Accordingly, embodiments of the present disclosure relate to techniques for determining an EVSE configuration at each location where an EVSE is installed.

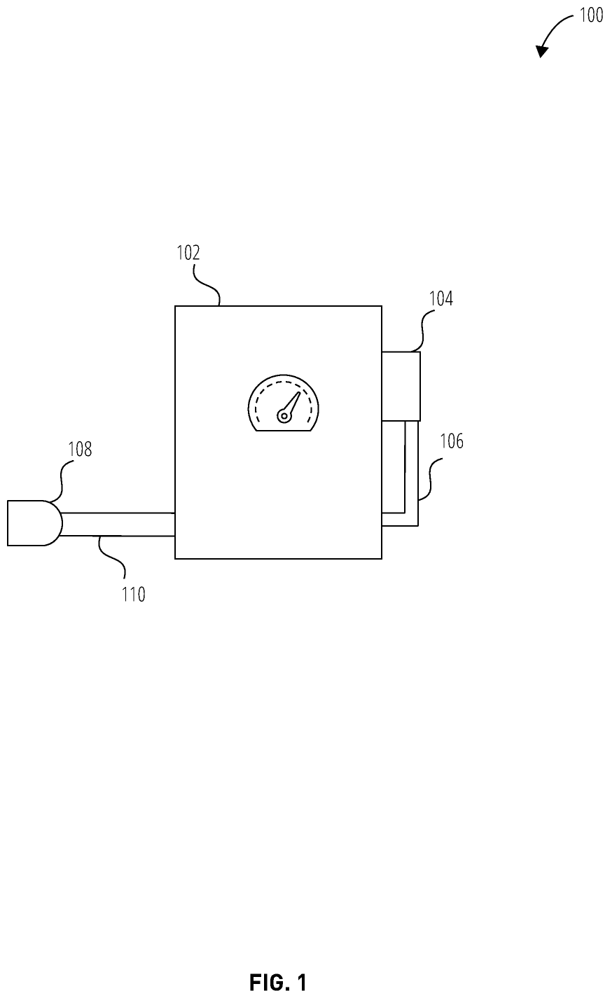

FIG. 1 shows a diagram 100 of an EVSE 102 in accordance with some embodiments of the present disclosure. In the embodiment shown, the EVSE 102 is portable and can be installed at and moved between different locations. In some embodiments, EVSE 102 is not portable and is installed at a fixed location. In the embodiment shown, EVSE 102 includes a nozzle 104 and a cord 106 connecting the nozzle 104 to the body of the EVSE 102. The nozzle 104 is configured for insertion into an EV port delivering electricity to an EV for charging a battery of the EV. In some embodiments, the cord 106 is extendible and/or retractable. In the embodiment shown, EVSE 102 includes a plug 108 configured for connection to an electrical outlet at an installation location and a cord 110 connecting the plug 108 to the body of the EVSE 102. In some embodiments, the cord 108 is extendible and/or retractable.

In some embodiments, the EVSE 102 includes a computing device including one or more processors and one or more storage devices, where the one or more processors are configured to execute software instructions and/or a program stored by the one or more storage devices. For example, the one or more processors may execute software instructions that configure EVSE 102 by setting values for one or more parameters for charging an electrical vehicle. In some embodiments, the values for the one or more parameters are operator selectable. In some embodiments, the values for the one or more parameters are automatically selected by the EVSE. In some embodiments, the values for the one or more parameters include operator selectable values and automatically selected values.

In some embodiments, the one or more parameters may be operational parameters and may include one or more of a maximum current for delivery by the EVSE at a particular location (e.g., installation location), user(s) that are authorized to utilize (e.g., use or charge a vehicle from) the EVSE, a time of usage of the EVSE (e.g., which may be adapted to obtain an optimized (or lowest) energy cost), whether the location (e.g., address) where the EVSE is installed is registered to a utility program (e.g., such as a demand response, where charging time may be determined according to utility convenience), whether the EVSE is in a load balancing group with a different EVSE in the same location, whether the EVSE is to dynamically change its maximum current based on the overall consumption at the location (e.g., a residence or home, commercial location, etc.) where it is installed (e.g., the overall consumption may be acquired by a paired clamp or direct connectivity to the smart meter in the location, using a communication protocol such as Zigbee or Powerline communications, for example), whether the EVSE is to adjust its charging times to minimize carbon dioxide (CO2) emissions, whether the EVSE is to be in a frequency regulation response group, whether the EVSE is authorized to export energy towards the grid (e.g., where the EVSE is a vehicle to grid (V2G) EVSE), whether the EVSE can export energy towards the home but not exceeding the home consumption, or any combination of the above mentioned. In some embodiments, one, a subset, or all of these parameters may be determined by the location where the EVSE is installed and/or agreement(s) between the user and the charging point operator (e.g., the company managing the EVSE) or the electric utility company. When connected to the grid through an appropriate adapter, the EVSE may be able to identify a maximum current allowed on that connection to the grid, for example, based on the input voltage, or on the voltage sensed on the pins of the adapter.

In some embodiments, one or more of these parameters (and corresponding values thereof) may be provided in an EVSE configuration file, where a different configuration file is determined for each different location where EVSE 102 is installed. Accordingly, when a configuration file is used, it may configure the EVSE 102 to operate according to the values for each of the one or more parameters that are included in the configuration file.

In some embodiments, the EVSE 102 is configured with a default configuration file that includes a default value for a maximum current parameter (DEFAULT_MAX) alone, or in addition to values for one or more of the other parameters. In some embodiments, the value of the maximum current parameter is the maximum advertised current for the EVSE 102. In some embodiments, if additional configuration file(s) are not downloaded for the EVSE 102 or the configuration of the EVSE 102 is not otherwise changed, the maximum advertised current is used as the default value for the maximum current parameter. In some embodiments, the default value for the maximum current parameter is the maximum advertised current for the EVSE 102 when the EVSE 102 is installed at a new location. In some embodiments, the default value for the maximum current parameter is zero when the EVSE 102 is installed in a new location, implying that a user is to then set a non-zero value for the maximum current parameter for the EVSE 102 at each new location (e.g., via an application on the user's computing device or a user interface of the EVSE 102) prior to any current draw by the EVSE 102. In some embodiments, the EVSE 102 is configured to have a default value of a maximum current parameter that is set by a user.

In whatever case, it is contemplated that a user may set/adjust the value for the maximum current parameter for the location away from the default. For example, the user may use a user interface of the EVSE 102, or a computing device (such as the computing device 206 to be described) to make these changes. These adjustments may be saved or written back to a configuration file for the location (wherever it may be stored, as described herein). These adjustments may be made such that the maximum current draw by the EVSE 102 at that location is within the applicable electrical conditions at that location. For example, if the user is aware that the electrical circuit used by the EVSE 102 at that location is on a 15 amp circuit breaker, the user may set the value for the maximum current parameter for the location to less than 15 amps.

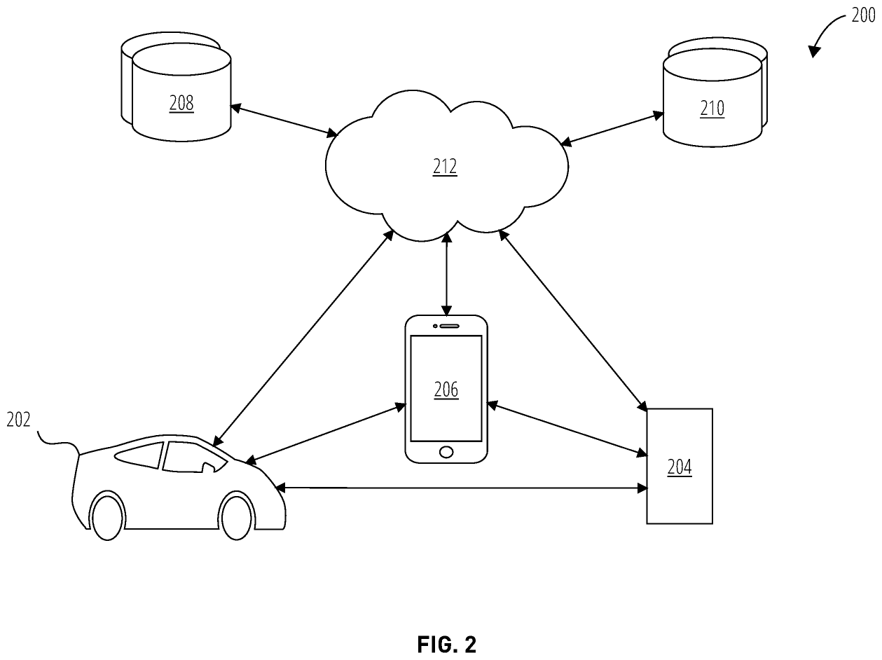

In some embodiments, EVSE 102 includes global positioning system (GPS) circuitry configured to determine a current location of the EVSE 102. In some embodiments, the EVSE 102 includes circuitry configured to determine a current location using triangulation based on two or more wireless communication network access points (e.g., for IEEE 802.11 (referred to herein as “WiFi®”) access points, Global System for Mobile Communication (GSM) access points, Long-Term Evolution (LTE) access points, Fifth-Generation (5G) mobile network access points, or the like) for which respective locations are known. In some embodiments, the EVSE 102 includes a communication interface to provide network connectivity using a communication network (e.g., Wi-Fi®, GSM, LTE, 5G, or the like) (e.g., network 212, discussed below) and/or communication via other techniques, such as Bluetooth®. In some embodiments, the EVSE 102 includes circuitry configured to determine a current location of the EVSE 102 using connectivity to a communication network. For example, the EVSE 102 may determine a current location by determining a location of an applicable Wi-Fi® service set identifier (SSID) and/or wireless local area network (WLAN) Access Point (AP), or by identifying the location of a public internet protocol (IP) address, given that public IP addresses associated with different places are different. In another example, the EVSE 102 may determine a current location of the EVSE 102 by implementing connectivity (e.g., via Bluetooth®) with a computing device (e.g., cellular or mobile phone, tablet, etc.) located proximal to the EVSE 102 such that the location of the computing device and EVSE 102 are substantially the same, and receiving location data from the computing device reflecting the current location from the computing device. The computing device may determine its location using included GPS circuitry of the computing device. For example, the EVSE 102 may establish connectivity (e.g., via Bluetooth®) with a proximally positioned mobile phone. The EVSE 102 may then determine a current location of the EVSE 102 by receiving, from the mobile phone, the location of the mobile phone as determined by the GPS circuitry of the mobile phone (e.g., as GPS coordinates), which is understood to also reflect the location of the EVSE 102, as described above. In some embodiments, this process may occur without explicit user input at the EVSE 102 (or even, in some cases, the proximal computing device), such that the EVSE 102 may autonomously identify its location. In some embodiments, the EVSE 102 may, alternatively or additionally, provide information regarding its location (e.g. Wi-Fi® access point media access control (MAC) address, public IP address, etc.) to the computing device 210 and/or database 208 via network 212 (discussed below with reference to FIG. 2), which can use that information to determine the location of the EVSE 102.

In some embodiments, one or more configuration files of the EVSE 102 are stored by the EVSE 102 (e.g., in local storage). In some embodiments, the one or more configuration files are alternatively or additionally stored in network (e.g. “cloud”) storage (e.g., database 208 and/or computing device 210 of FIG. 2, discussed below), and the EVSE 102 downloads a configuration file for a particular location when it is determined that the EVSE 102 is installed at that location. For example, the EVSE 102 may determine its current location (e.g., a location where it is currently installed) and download a configuration file that corresponds to the current location. In another example, the EVSE 102 may determine its current location and use the current location to obtain a configuration file corresponding to that location from local storage. In some embodiments, the configuration file specifies the maximum current available for delivery by the EVSE 102 at that location. In some embodiments, the EVSE 102 determines that it is installed at a particular location and automatically configures itself with the EVSE configuration file associated with that location. In some embodiments, a configuration file is manually selected by a user of the EVSE 102, for example, via a user interface (not shown) of the EVSE 102. In some embodiments, a configuration file for the EVSE 102 is manually selected, for example, via a computing device (e.g., cellular or mobile phone, tablet, etc.) connected to the EVSE 102 (e.g., via Bluetooth®, Wi-Fi®, cable, etc.). In some embodiments, a configuration file is manually selected, for example, via a computing device (e.g., cellular or mobile phone, tablet, etc.) connected to the EVSE 102 via a cellular network or wide area network (e.g., the Internet) and/or via a mobile application of the computing device.

In some embodiments, the configuration file may be shared by a network, such that a plurality of portable EVSE 102 can access the configuration file. Stated otherwise, the configuration file may be associated with the location and stored in a distributed or otherwise accessible platform (e.g., a cloud computing environment) where multiple portable EVSE 102 can access the information in the configuration file. In some embodiments, the location (e.g., physical properties of the location) may be altered, such that a configuration of the location changes. For example, a 240 volt outlet may be installed to be used for EV charging instead of a 120 volt outlet. Or the wiring of a location may be updated or enhanced. In some embodiments, the location configuration file may be updated or otherwise altered to store the new information. In other embodiments, a new location configuration file may be prepared and stored. The new configuration file may be stored in place of the original configuration file, or the original configuration file may simply be deleted or otherwise discarded.

FIG. 2 shows a system 200 according to some embodiments of the present disclosure. In some embodiments, system 200 includes a vehicle 202 and a charging station 204. For example, the vehicle 202 may be an EV discussed above and/or the charging station 204 may be an EVSE discussed above (e.g., EVSE 102). In some embodiments, charging station 204 may be portable and installed in various different locations. The vehicle 202 may be charged using the charging station 204, where electricity may be provided from the charging station 204 to a battery of the vehicle 202.

In some embodiments, the system 200 includes a computing device 206. For example, the computing device 206 may be a cellular phone, tablet computer, laptop computer, or the like. In some embodiments, the computing device 206 includes GPS circuitry configured to determine a current location of the computing device 206. In some embodiments, the computing device 206 includes circuitry configured to determine a current location of the computing device using triangulation based on two or more wireless communication network access points for which respective locations are known. For example, one, some, or each of the two or more wireless communication network access points may be a Wi-Fi® access point. In another example, one, some, or each of the two or more wireless communication network access points may be a node of a mobile communication network (e.g., a cellular network such as GSM, LTE, 5G, or the like). In some embodiments, the computing device 206 is used to access one or more configuration files (e.g., stored internally in memory of the computing device 206 and/or at a remote location such as one or more databases 208) for configuring the charging station 204. For example, a user may select a configuration file and/or a default current for the charging station 204 using a software application accessed by the computing device 206.

In some embodiments, the computing device 206 is a computing device of a driver, occupant, or individual otherwise associated with the vehicle 202. In some embodiments, the computing device 206 is in wireless or wired communication with the vehicle 202. For example, the vehicle 202 may include short range communication (e.g., Bluetooth®) functionality where, for example, an onboard computing device of the vehicle 202 may transmit data to and/or receive data from one or more of the computing devices 206 (e.g., via Bluetooth®) located within a communication range of the vehicle 202. In some embodiments, the computing device 206 is in wireless or wired communication with the charging station 204. For example, the charging station 204 and/or the computing device 206 may also include short range communication (e.g., Bluetooth®) functionality and may transmit data to and/or receive data from each other and/or other computing devices located within a communication range of the charging station 204 and/or the computing device 206, respectively. The vehicle 202, charging station 204, and computing device 206 may further each use a network 212 for communication with each other, as discussed below.

In some embodiments, the system 200 includes one or more databases 208. For example, a database 208 may store data from or used by one or more of the vehicle 202, the charging station 204, the computing device 206, and/or the computing device 210 (discussed below). In some embodiments, the one or more databases 208 stores one or more configuration files for a charging station 204.

In some embodiments, the system 200 includes one or more other computing devices 210. For example, a computing device 210 may be a remote computing device (e.g., a cloud computer or the like) that communicates with one or more of the vehicle 202, the charging station 204, the computing device 206, and/or the database 208 directly or via the network 212. In some embodiments, the computing device 210 determines whether a particular user (e.g., vehicle driver, occupant, or person associated with the vehicle) is authorized to charge or have vehicle 202 charged at a particular charging station 204. For example, the computing device 210 may process data (e.g., identification data, security token data, etc.) from the vehicle 202, the charging station 204, the computing device 206, and/or the database 208 to determine whether a user is authorized to charge or have the vehicle 202 charged by the charging station 204. In some embodiments, the computing device 210 is configured to control charging of the vehicle 202 and/or determine an estimated state of charge (SoC) of the vehicle 202. For example, the computing device 210 may receive one or more of location data, SoC data, vehicle characteristics, and the like from the vehicle 202, the charging station 204, the computing device 206, and/or the database 208 and make a determination whether the vehicle is authorized to or otherwise can be charged by the charging station 204 at the present location

In some embodiments, the system 200 includes a network 212. For example, the network 212 may be a cellular network, the Internet, a wide area network (WAN), a local area network (LAN), or any other type of communications network (and including any combination of these). In some embodiments, one or more of the vehicle 202, the charging station 204, the computing device 206, the database 208, and/or the computing device 210 use the network 212 to communicate with each other and/or other computing devices. In some embodiments, each of the devices/elements of the system 200 includes a network interface that allows for communication within the system 200 via the network 212.

In some embodiments, the computing device 206 communicates with the vehicle 202 and/or the charging station 204 directly (e.g., via Bluetooth® or a different short range communication protocol) or indirectly via the network 212. In some embodiments, in addition or alternatively, the vehicle 202 and the charging station 204 communicate with each other directly (e.g., via Bluetooth® or a different short range communication protocol) or indirectly via the network 212.

In some embodiments, the charging station 204 is implemented as EVSE 102. When the EVSE 102 is installed at a location, the EVSE 102 determines the location where it is installed and further determines a configuration file for that location. As discussed above, the location may be determined by EVSE 102 using its own GPS circuitry and/or other internal methods and/or by obtaining location information from a computing device located within a predetermined distance (e.g., 1 foot, 2 feet, 5 feet, 10 feet, etc.) of the EVSE 102 (e.g., via Bluetooth®). The configuration file may specify a maximum current for delivery by the EVSE 102, for example, at the location where EVSE 102 is installed, and/or values for one or more other parameters as discussed herein. In some embodiments, the configuration file is stored on the EVSE 102. In some embodiments, the configuration file is obtained by the EVSE 102 from the one or more databases 208.

In some embodiments, the system 200 is used to control charging of the vehicle 202 and/or estimate an SoC for the vehicle 202. For example, the charging control and/or SoC estimation may be performed by the computing device 206 and/or the computing device 210.

In some embodiments, the computing device 206 may store a software application that facilitates configuring and/or manually setting values for one or more parameters of the charging station 204, estimating the SoC for the vehicle 202, and/or controlling charging of the vehicle 202.

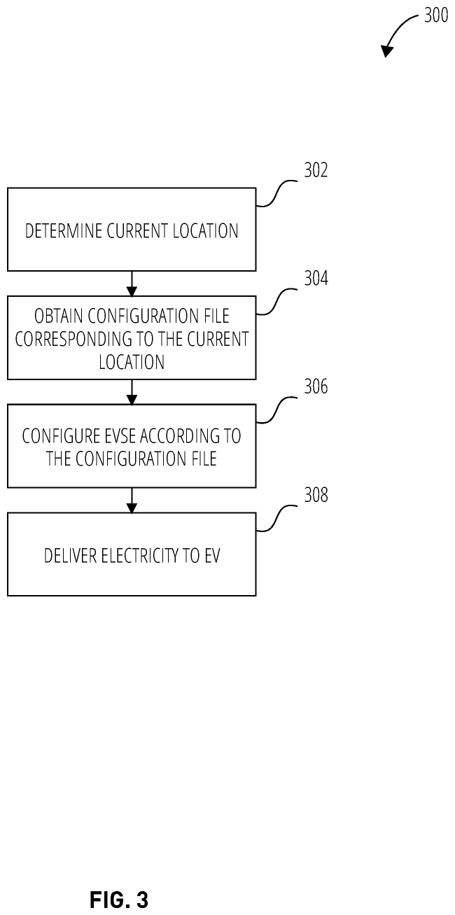

FIG. 3 is a flow diagram of a process 300 for configuring an EVSE (e.g., EVSE 102) that has been installed at a location for charging an EV in accordance with some embodiments. At block 302, a current location of the EVSE is determined. In some embodiments, the EVSE determines the current location using internal GPS circuitry. In some embodiments, the EVSE determines the current location by using internal circuitry configured to determine a current location using triangulation based on two or more wireless communication network access points (e.g., for Wi-Fi®, GSM, LTE, 5G, or the like) for which respective locations are known.

In some embodiments, the EVSE includes circuitry configured to determine a current location of the EVSE using connectivity to a communication network. For example, the EVSE 102 may determine a current location by determining a location of an applicable Wi-Fi® SSID and/or WLAN AP. In some embodiments, the EVSE determines the current location by implementing connectivity (e.g., via Bluetooth®) with a computing device (e.g., cellular or mobile phone, tablet, etc.) located proximal to the EVSE 102 such that the location of the computing device and EVSE 102 are substantially the same, and receives location data reflecting the current location from the computing device. In some embodiments, the computing device determines the location data using GPS circuitry of the device.

At block 304, the EVSE obtains a configuration file for configuring the EVSE for delivering electricity to an EV, wherein the configuration file corresponds to the determined current location. In some embodiments, the current location is compared to one or more locations associated with one or more configuration files, and when a match between locations occurs (e.g., an exact match or a match where the compared locations are within a predefined range of each other), the configuration file associated with the matched location is obtained. In some embodiments, the EVSE comprises one or more memory storing the configuration file, and the EVSE obtains the configuration file from the one or more memory. In some embodiments, the configuration file is stored in remote storage (e.g., one or more databases 208), and the EVSE obtains the configuration file from the remote storage (e.g., via network 212, via Bluetooth® connection, or otherwise). In some embodiments, the configuration file is stored within a profile of the user and/or account holder associated with the EVSE, alone or along with one or more other configuration files corresponding to other locations. In some embodiments, the configuration file includes one or more parameters for charging an EV. In some embodiments, the one or more parameters include a maximum current for delivery by the EVSE at the current location (e.g., installation location).

At block 306, the EVSE is configured for delivering electricity to an EV according to the configuration file. In some embodiments, one or more of a maximum current for delivery by the EVSE, user(s) that are authorized to utilize (e.g., use, or charge a vehicle from) the EVSE, a time of usage of the EVSE (e.g., which may be adapted to obtain an optimized (or lowest) energy cost), whether the location/address where the EVSE is installed is registered to a utility program (e.g., such as a demand response, where charging time may be determined according to utility convenience), whether the EVSE is in a load balancing group with a different EVSE in the same location, whether the EVSE is to dynamically change its maximum current based on the overall consumption at the location where it is installed (e.g., based on the consumption of the residence or home where the EVSE is installed, where the overall consumption of the residence or home may be acquired by a paired clamp or direct connectivity to the smart meter in the location using, for example, a communication protocol such as Zigbee or Powerline communications), whether the EVSE is to adjust its charging times to minimize CO2 emissions, whether the EVSE is to be in a frequency regulation response group, whether the EVSE is authorized to export energy towards the grid (e.g., where the EVSE is a V2G EVSE), whether the EVSE can export energy towards the home but not exceeding the home consumption, or any combination of the above mentioned, is configured according to the configuration file.

At block 308, the configured EVSE delivers electricity to an EV in accordance with the values of one or more parameters of the configuration file. In some embodiments, the EV is charged by the delivered electricity.

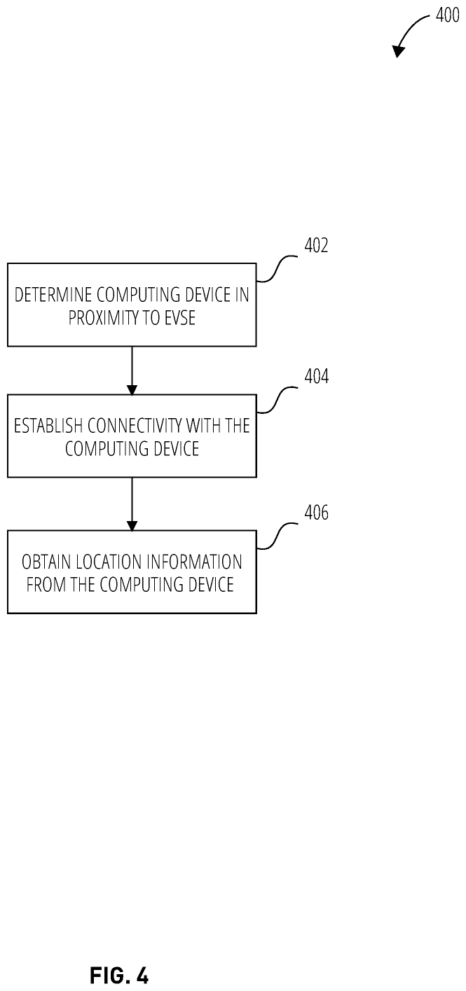

FIG. 4 shows a process 400 for determining the current location of an EVSE (e.g., EVSE 102) using a computing device external to the EVSE in accordance with some embodiments. In some embodiments, block 302 of process 300 uses the process 400 to determine the current location of the EVSE.

At block 402, a computing device in proximity to the EVSE is identified. In some embodiments, the computing device is a cellular or mobile phone, tablet, personal computer, or the like. The EVSE may identify the computing device by, for example, discovering a signal (e.g., a Bluetooth® signal) provided by or from the computing device. In some embodiments, the proximity defines a distance or radius away from the EVSE. For example, the distance or radius may be less than or equal to 1 foot, 2, feet, 5 feet, 10 feet, 20 feet, 50 feet, and/or 100 feet. In some embodiments, the appropriate proximity of the EVSE to the computing device may be established based on an ability of the EVSE to receive a signal (e.g., a Bluetooth® signal) from the computing device. In some embodiments, the appropriate proximity of the EVSE to the computing device may be established based on a signal strength of a signal (e.g., a Bluetooth® signal) provided by the computing device to the EVSE.

At block 404, connectivity between the EVSE and the computing device is established. In some embodiments, the connectivity is Bluetooth® connectivity. In some embodiments, the connectivity is via a communications network such as the Internet or a cellular network (e.g., GSM, LTE, 5G, or the like). In some embodiments, the EVSE initiates the establishment of the connectivity between the EVSE and the computing device.

At block 406, the EVSE obtains location information from the computing device. In some embodiments, the location information includes GPS coordinates or other GPS location data. In some embodiments, the obtained location information reflects a location of the EVSE since the location is of a computing device in proximity to the EVSE.

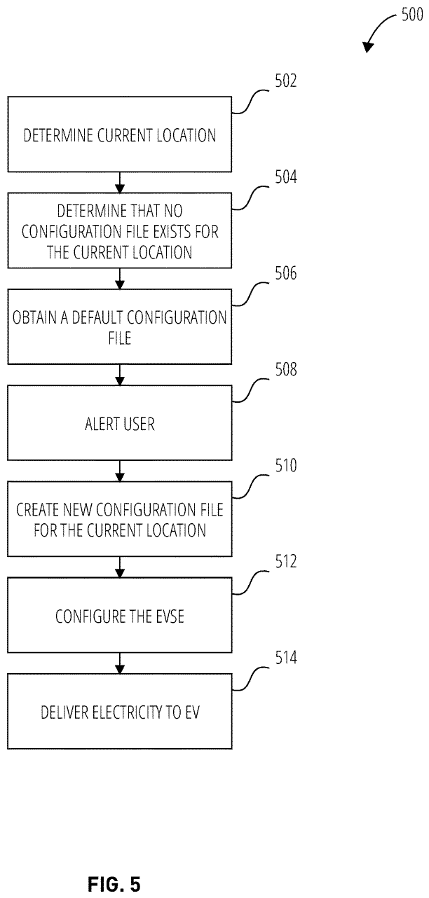

FIG. 5 shows a process 500 for configuring an EVSE (e.g., EVSE 102) that has been installed at a location for charging an EV in accordance with some embodiments. At block 502, the EVSE determines the current location. The determination at block 502 may be the same as the determination in block 302 of process 300, discussed above.

At block 504, a determination is made that there no configuration file exists corresponding to the determined current location. In some embodiments, the current location is compared to one or more locations associated with one or more configuration files, and the determination that no configuration file exists is made when a match does not occur between locations (e.g., an exact match does not occur and/or a match where the compared locations are within a predefined range of each other does not occur). If a configuration file that corresponds to the determined current location is corrupted or otherwise not available, it may be determined not to exist at block 504.

At block 506, a default configuration file including one or more default parameters (along with one or more default values for those one or more default parameters) regarding configuration of the EVSE is obtained by the EVSE. In some embodiments, the EVSE comprises one or more internal memory storing the default configuration file, and the EVSE obtains the default configuration file from the one or more memory. In some embodiments, the default configuration file is stored in remote storage (e.g., one or more databases 208), and the EVSE obtains the default configuration file from the remote storage (e.g., via network 212, via Bluetooth® connection, or otherwise). In some embodiments, the default configuration file is stored within a profile of the user and/or account holder associated with the EVSE, alone or along with one or more other configuration files. In some embodiments, the default configuration file includes one or more default parameters for charging an electrical vehicle. In some embodiments, the default configuration file includes a default maximum current parameter (DEFAULT_MAX) for current delivered by the EVSE to an EV. In some embodiments, the value of the default maximum current parameter is the maximum advertised current for the EVSE. In some embodiments, the value of the default maximum current parameter is zero.

At block 508, a user of the EVSE and/or an account holder associated with the EVSE is alerted that no configuration file exists for the current location. In some embodiments, the alert is received by a computing device (e.g., computing device 206) of the user and/or account holder. In some embodiments, the alert is transmitted by a remote database (e.g., database 208) that stores one or more configuration files to the computing device. In some embodiments, the alert notifies that the value of the default maximum current parameter requires adjustment, and the user and/or account holder may adjust the value via a user interface of computing device or a user interface of the EVSE itself. For example, the alert may ask that the user enter a value for a maximum current parameter for the EVSE at the current location.

At block 510, a new configuration file for the current location is created. In some embodiments, the new configuration file includes one or more parameters having values of corresponding parameters of the default configuration file. Further, the new configuration file may include parameters having one or more values that are manually settable by a user of and/or account holder associated with the EVSE, and/or that are adjustable relative to that same value as found in the default configuration file. For example, the value for the maximum current parameter for the EVSE may be set to zero by the default configuration file, and a user may then manually adjust the value of the maximum current parameter. In some embodiments, the new configuration is associated with the determined current location of block 502. For example, the new configuration file includes the current location defined by a Wi-Fi® SSID and/or WLAN AP of the location, and/or the current location defined by the obtained location data (e.g., via Bluetooth®) from a computing device in proximity of the EVSE. In some embodiments, the new configuration file is saved in internal memory of the EVSE and/or transmitted to and saved by a remote storage device (e.g., databases 208). In some cases, saving the new configuration file to both the remote storage device and the internal memory of the EVSE may provide the EVSE with redundant ways to later access/receive the new configuration file should one of the ways be inoperable (e.g., due to a failure in the memory of the EVSE and/or a lack of network connectivity with the remote storage device). In some embodiments, the new configuration file is a derivative of and/or a modification to the default configuration file.

At block 512, the EVSE is configured. In some embodiments, the EVSE is configured in accordance with the obtained default configuration file. In some embodiments, the EVSE is configured in accordance with the obtained default configuration file as further modified by values of one or more (of perhaps the same) parameters that are manually entered and/or adjusted by the user and/or account holder (e.g., in the manner discussed in relation to block 510).

At block 514, the configured EVSE delivers electricity to an EV in accordance with values of the one or more parameters of the configuration file. In some embodiments, the EV is charged by the delivered electricity.

Other orderings for the blocks 502 through 514 are also contemplated. For example, it may be that an EVSE obtains a default configuration file (as in block 506), alerts a user (as in block 510), configures the EVSE (as in block 512), and begins delivering electricity to the EV (as in block 514) prior to the creation of a new configuration file for the current location (as in block 510).

The processes 300, 400, and 500 may be performed by one or multiple components of the system 200. For example, blocks of processes 300, 400, and 500 may be performed by one or multiple of charging station 204, computing device 206, database(s) 208, and/or computing device 210.

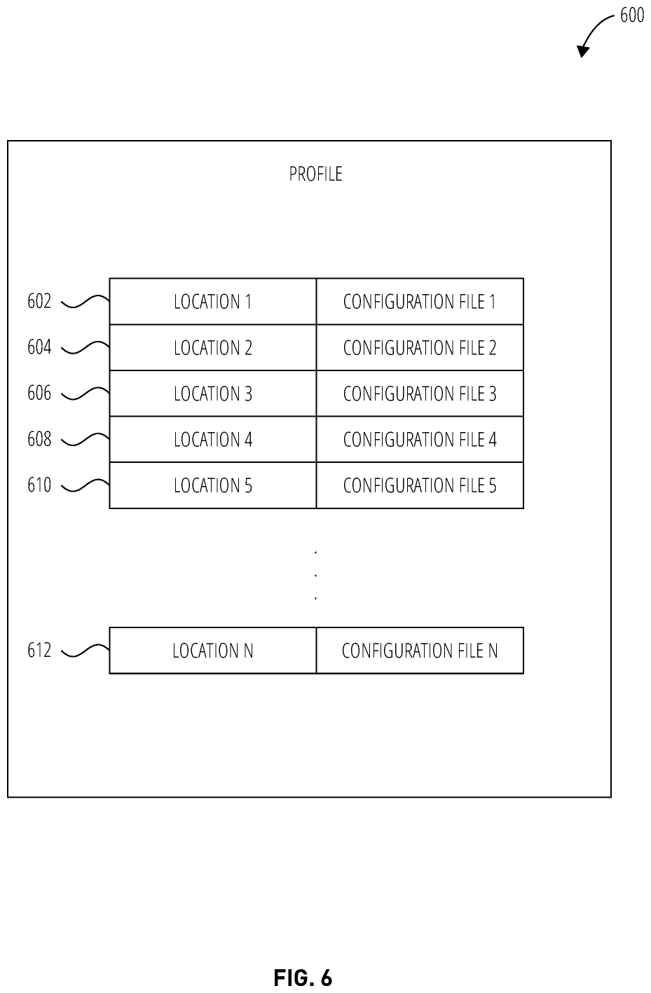

FIG. 6 shows a profile 600 for a user of the EVSE and/or an account holder associated with an EVSE in accordance with some embodiments. As shown, the profile 600 includes configuration files 602 through 612 (configuration files 1 through N) that correspond to various locations 1 through N. In some embodiments, the geolocation (e.g., GPS coordinates) and/or address and/or Wi-Fi® SSID, WLAN AP, and/or MAC address associated with a location is stored in a configuration file. In some embodiments, each configuration file is visible to a user and/or account holder via a dashboard or user interface (e.g., software application), accessed by a computing device, that displays the profile 600. Copies of the profile 600 may be stored on an EVSE itself (e.g., included in the charging station 204), and/or on a database (e.g., a database 208) or a network-accessible computing device (e.g., a computing device 210) such that it is obtainable at/modifiable by the EVSE and/or a computing device of a user (e.g., the computing device 206) over a network (e.g., the network 212), in the manner that has been described above.

### EXAMPLE EMBODIMENTS

The following are some example embodiments within the scope of the disclosure. In order to avoid complexity in providing the disclosure, not all of the examples listed below are separately and explicitly disclosed as having been contemplated herein as combinable with all of the others of the examples listed below and other embodiments disclosed hereinabove. Unless one of ordinary skill in the art would understand that these examples listed below (and the above disclosed embodiments) are not combinable, it is contemplated within the scope of the disclosure that such examples and embodiments are combinable.

### Example 1

An electric vehicle supply equipment (EVSE) comprising: a processor; and a memory storing instructions that, when executed by the processor, cause the EVSE to: determine a current location of the EVSE; obtain a configuration file for configuring the EVSE for delivering electricity to an electric vehicle (EV), the configuration file corresponding to the current location of the EVSE; configure the EVSE according to the obtained configuration file, the configuring setting a maximum electrical current for delivery by the EVSE to the EV; and deliver electricity to the EV.

### Example 2

The EVSE of Example 1, wherein determining the current location of the EVSE comprises: identifying a computing device in proximity to the EVSE; establishing connectivity with the computing device; and obtaining location information from the computing device, the location information reflecting the current location of the EV SE.

### Example 3

The EVSE of Example 2, wherein the proximity is a distance from the EVSE that is less than 10 feet.

### Example 4

The EVSE of Example 2, wherein the connectivity with the computing device is a Bluetooth® connection.

### Example 5

The EVSE of Example 2, wherein the location information comprises global positioning system (GPS) coordinates.

### Example 6

The EVSE of Example 1, wherein obtaining the configuration file comprises: determining that the configuration file does not exist; creating the configuration file based on a default configuration file.

### Example 7

The EVSE of Example 6, wherein the default configuration file is obtained from an internal memory of the EVSE.

### Example 8

The EVSE of Example 6, wherein the default configuration file is obtained from a remote storage device.

### Example 9

The EVSE of Example 6, further comprising alerting a user computing device that the configuration file does not exist.

### Example 10

The EVSE of Example 9, further comprising receiving values for one or more user settable parameters, wherein creating the configuration file further comprises using the values for the one or more user settable parameters in the configuration file.

### Example 11

The EVSE of Example 10, wherein the values are received from the user computing device.

### Example 12

The EVSE of Example 10, wherein the values are received via a user interface of the EVSE.

### Example 13

The EVSE of Example 1, wherein a maximum current delivered by the EVSE is configured according to the configuration file.

### Example 14

The EVSE of Example 1, wherein one or more parameters for charging the EVSE are configured according to the configuration file.

### Example 15

The EVSE of Example 1, wherein whether the EVSE participates in load balancing is configured according to the configuration file.

### Example 16

An electric vehicle supply equipment (EVSE) comprising: circuitry to determine a current location of the EVSE; a processor; and a memory storing instructions that, when executed by the processor, cause the EVSE to: configure one or more operational parameters for delivering electricity to an electric vehicle (EV) based on one or more values for the one or more operational parameters of a configuration file that corresponds to the current location of the EVSE; and deliver electricity to the EV according to the configuration of the one or more operational parameters.

### Example 17

The EVSE of Example 16, wherein the circuitry to determine a current location of the EVSE comprises wireless communication technology to: establish connectivity with a computing device in proximity to the EVSE; and obtain location information from the computing device, the location information reflecting the current location of the EVSE.

### Example 18

The EVSE of Example 16, wherein the circuitry to determine a current location of the EVSE comprises global positioning system (GPS) circuitry.

### Example 19

The EVSE of Example 16, wherein the one or more operational parameters include one or more of: a maximum current for delivery by the EVSE at the current location; whether the EVSE is to be in a frequency regulation response group; whether the EVSE is in a load balancing group with a different EVSE in the same location; and whether the EVSE is to dynamically change its maximum current based on the overall consumption at the current location.

### Example 20

The EVSE of Example 16, wherein the one or more operational parameters include one or more of: an indication of one or more users that are authorized to utilize the EVSE, a time of usage of the EVSE; and whether the location where the EVSE is installed is registered to a utility program.

### Example 21

The EVSE of Example 16, wherein the one or more operational parameters include one or more of: whether the EVSE is authorized to export energy towards the grid; and whether the EVSE can export energy towards a local grid of a facility of the current location, but not exceeding the facility consumption.

The described features, operations, or characteristics may be arranged and designed in a wide variety of different configurations and/or combined in any suitable manner in one or more embodiments. Thus, the detailed description of the embodiments of the systems and methods is not intended to limit the scope of the disclosure, as claimed, but is merely representative of possible embodiments of the disclosure. In addition, it will also be readily understood that the order of the steps or actions of the methods described in connection with the embodiments disclosed may be changed as would be apparent to those skilled in the art. Thus, any order in the provided drawings and/or descriptions is for illustrative purposes only and is not meant to imply a required order, unless specified to require an order.

Embodiments may include various steps, which may be embodied in machine-executable instructions to be executed by a general-purpose or special-purpose computer (or other electronic device). Alternatively, the steps may be performed by hardware components that include specific logic for performing the steps, or by a combination of hardware, software, and/or firmware.

At least some embodiments may comprise a computer program product including a computer-readable storage medium having stored instructions and/or data thereon that may be used to program a computer (or other electronic device) to perform processes described herein. The computer-readable storage medium comprises at least a non-transient storage medium, such as, e.g., a hard drive, a fixed disk, a removable disk, a floppy diskette, an optical disk, a CD-ROM, a CD-RW, a DVD-ROM, a DVD-RW, a read-only memory (ROM), a random access memory (RAM), an erasable programmable ROM (EPROM), an electrically erasable programmable ROM (EEPROM), a magnetic card, an optical card, a solid-state memory device, or other types of media/machine-readable media suitable for storing electronic instructions and/or data.

A software module, module, or component may include any type of computer instruction or computer executable code located within a memory device and/or computer-readable storage medium, as is well known in the art.

It will be obvious to those having skill in the art that many changes may be made to the details of the above described embodiments without departing from the underlying principles of the invention. The scope of the present invention should, therefore, be determined only by the following claims.

1. An electric vehicle supply equipment (EVSE) comprising:
a processor; and
a memory storing instructions that, when executed by the processor, cause the EVSE to:
determine a current location of the EVSE;
obtain a configuration file for configuring the EVSE for delivering electricity to an electric vehicle (EV), the configuration file corresponding to the current location of the EVSE;
configure the EVSE according to the obtained configuration file, the configuring setting a maximum electrical current for delivery by the EVSE to the EV; and
deliver electricity to the EV.

2. The EVSE of claim 1, wherein determining the current location of the EVSE comprises:
identifying a computing device in proximity to the EVSE;
establishing connectivity with the computing device; and
obtaining location information from the computing device, the location information reflecting the current location of the EVSE.

3. The EVSE of claim 2, wherein the proximity is a distance from the EVSE that is less than 10 feet.

4. The EVSE of claim 2, wherein the connectivity with the computing device is a Bluetooth® connection.

5. The EVSE of claim 2, wherein the location information comprises global positioning system (GPS) coordinates.

6. The EVSE of claim 1, wherein obtaining the configuration file comprises:
determining that the configuration file does not exist;
creating the configuration file based on a default configuration file.

7. The EVSE of claim 6, wherein the default configuration file is obtained from an internal memory of the EVSE.

8. The EVSE of claim 6, wherein the default configuration file is obtained from a remote storage device.

9. The EVSE of claim 6, further comprising alerting a user computing device that the configuration file does not exist.

10. The EVSE of claim 9, further comprising receiving values for one or more user settable parameters, wherein creating the configuration file further comprises using the values for the one or more user settable parameters in the configuration file.

11. The EVSE of claim 10, wherein the values are received from the user computing device.

12. The EVSE of claim 10, wherein the values are received via a user interface of the EVSE.

13. The EVSE of claim 1, wherein a maximum current delivered by the EVSE is configured according to the configuration file.

14. The EVSE of claim 1, wherein one or more parameters for charging the EVSE are configured according to the configuration file.

15. The EVSE of claim 1, wherein whether the EVSE participates in load balancing is configured according to the configuration file.

16. An electric vehicle supply equipment (EVSE) comprising:
circuitry to determine a current location of the EVSE;
a processor; and
a memory storing instructions that, when executed by the processor, cause the EVSE to:
configure one or more operational parameters for delivering electricity to an electric vehicle (EV) based on one or more values for the one or more operational parameters of a configuration file that corresponds to the current location of the EVSE; and
deliver electricity to the EV according to the configuration of the one or more operational parameters.

17. The EVSE of claim 16, wherein the circuitry to determine a current location of the EVSE comprises wireless communication technology to:
establish connectivity with a computing device in proximity to the EVSE; and
obtain location information from the computing device, the location information reflecting the current location of the EVSE.

18. The EVSE of claim 16, wherein the circuitry to determine a current location of the EVSE comprises global positioning system (GPS) circuitry.

19. The EVSE of claim 16, wherein the one or more operational parameters include one or more of:
a maximum current for delivery by the EVSE at the current location;
whether the EVSE is to be in a frequency regulation response group;
whether the EVSE is in a load balancing group with a different EVSE in the same location; and
whether the EVSE is to dynamically change its maximum current based on the overall consumption at the current location.

20. The EVSE of claim 16, wherein the one or more operational parameters include one or more of:
an indication of one or more users that are authorized to utilize the EVSE,
a time of usage of the EVSE; and
whether the location where the EVSE is installed is registered to a utility program.

21. The EVSE of claim 16, wherein the one or more operational parameters include one or more of:
whether the EVSE is authorized to export energy towards the grid; and
whether the EVSE can export energy towards a local grid of a facility of the current location, but not exceeding the facility consumption.
